(19) United States
(12) Patent Application Publication
(10) Pub. No.: US 2007/0221645 A1
(43) Pub. Date: Sep. 27, 2007

(54) Electric blanket controller and electric blanket with such controller

(75) Inventors: Mark A. Castracane, Hattiesburg, MO (US); Dale C. Thomas, Cleveland, GA (US); Henry H. Adair, Canton, GA (US)

Correspondence Address: DICKSTEIN SHAPIRO LLP, 1177 AVENUE OF THE AMERICAS (6TH AVENUE), NEW YORK, NY, 10036-2714, US

(73) Assignee: WP IP, LLC, Carson City, NV (US)

(21) Appl. No.: 11/580,313

(22) Filed: Oct. 12, 2006

Related U.S. Application Data
(60) Provisional application No. 60/726,043, filed on Oct. 12, 2005.

(51) Int. Cl. H05B 3/00

(52) U.S. Cl. 219/212

(57) ABSTRACT

In general, the controller of the present invention senses the temperature of the electric blanket in which the controller is used, and controls the temperature accordingly. The temperature is sensed using both the PTC and NTC methods discussed below, and contained within the wire. The controller adjusts the power delivered to the electric blanket based on the temperature sensed as well as on a heat setting by the user of the blanket. Additionally or alternatively, the controller uses the sensed temperature information to guard against overheating, caused either by inadvertent consumer misuse or component failure.

### CROSS-REFERENCE TO RELATED APPLICATION

This patent application claims the benefit of U.S. Provisional Patent Application No. 60/726,043 filed Oct. 12, 2005, now pending, which is incorporated herein by reference.

### FIELD OF THE INVENTION

The present invention relates to an electric blanket controller and an electric blanket formed with such an electric blanket controller.

### BACKGROUND OF THE INVENTION

Electric blankets or carpets, have been used in households to conveniently provide heating to a user. Typically, an electric blanket has a blanket body with a heating wire embedded therein. A temperature control device is provided for connecting the heating wire to an electricity power supply and for adjusting the temperature of the blanket body.

Detailed descriptions of various conventional electric blankets as well as the associated temperature control devices can be found in U.S. Pat. No. 3,564,203 and U.S. Patent Application Publication No. 2003/0132212A1.

### SUMMARY OF THE INVENTION

The controller of the present invention senses the temperature of the electric blanket in which the controller is used, and controls the temperature accordingly. For example, the controller can employ a detector for detecting a temperature of a heating element embedded in the electric blanket and a temperature controller for adjusting the temperature on the basis of the detected temperature. In one embodiment, the controller adjusts the power delivered to the electric blanket based on the temperature sensed as well as on a heat setting by the user of the electric blanket. Additionally or alternatively, the controller uses the sensed temperature information to guard against overheating, caused either by inadvertent consumer misuse or component failure.

### BRIEF DESCRIPTION OF THE DRAWINGS

FIG. 1 shows an embodiment of an electric blanket including a controller.

FIG. 2 shows a partial fragmentary view, partially broken away, of a heating wire incorporated in the electric blanket.

FIG. 3 shows one embodiment of a circuitry for the controller.

FIG. 4 shows another embodiment of a circuitry for the controller.

FIG. 5 is a flowchart illustrate the overall operational flow for the power up the operation of the controller.

FIG. 6 is a flowchart illustrating the normal mode operation of the controller.

FIG. 7 shows an exemplary LCD display for the controller.

FIG. 8 shows one embodiment of the button arrangement for the controller.

### DETAILED DESCRIPTION OF THE INVENTION

This application relates to a controller for an electric blanket. An exemplary embodiment of hardware and firmware to implement to present invention is shown herein. However, the present invention is not limited to the disclosed embodiment, which is discussed for illustrative purposes.

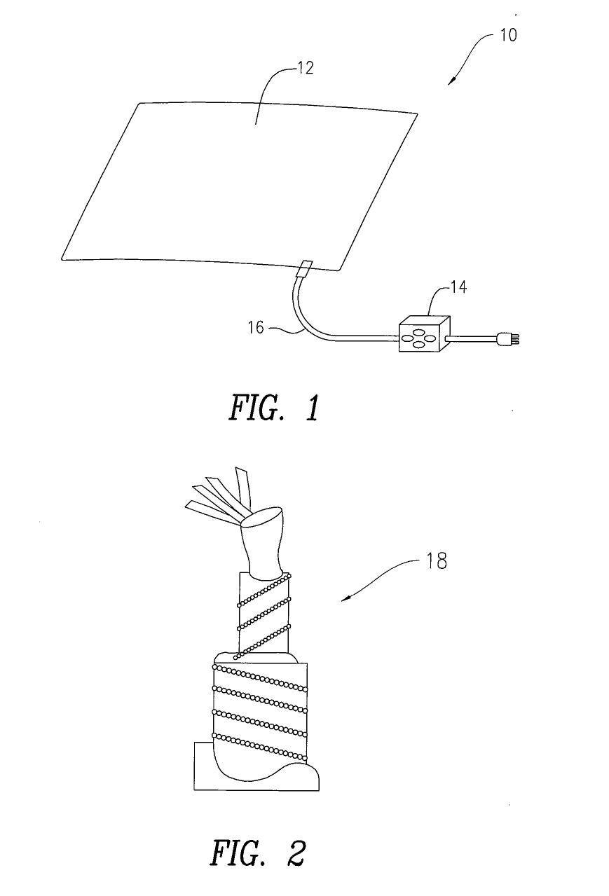

FIG. 1 shows one embodiment of the electric blanket 10 comprising a blanket body 12 and a controller 14 joined to each by a cable 16. The blanket body 12 can be in any of various conventional forms, such as a bedcover, or a blanket which either directly covers a user's body or spreads over a bed or floor for a user to lay on. The controller 14 is formed to control the setting and/or operation of the electric blanket 10 as will be described in great detail below. In one embodiment, the controller 14 is particularly applicable for working with heating elements of the type constructed of Type TT900 triaxial wire made by Thermocable Flexible Elements Ltd. of the United Kingdom.

FIG. 2 shows an embodiment of a heating element 18, such as a heating wire, embedded in the blanket body 12. In one embodiment, the heating elements 18 are of the type constructed of Type TT900 triaxial wire made by Thermocable Flexible Elements Ltd. of the United Kingdom. While the present invention is particularly useful to work with such heating elements 18, the invention is not limited to such elements and may be used in other heating elements, as will be understood by those skilled in the art.

The heating elements 18 use the known positive temperature coefficient (PTC) method of regulation for overall temperature monitoring, and also uses the known negative temperature coefficient (NTC) method for a resettable “hot spot” detection. The NTC relates to the relationship between the temperature of the material and its resistance. In NTC, as the temperature of the material increases, the resistance of the material decreases. Detection of decreased resistance can thus be used to detect increases temperature using NTC. In PTC measurement, the material is such that the resistance increases with increasing temperature.

The controller 14 senses the temperature of the electric blanket 10 in which the heating elements 18 are used, and controls the temperature accordingly. The temperature is sensed using both the PTC and NTC methods discussed above, and contained within the wire. The two methods of sensing are utilized by the controller 14.

The controller 14 adjusts the power delivered to the blanket body 12 based on the temperature sensed as well as on a heat setting by the user of the blanket body 12. The controller 14 also uses the sensed temperature information to guard against overheating, caused either by inadvertent consumer misuse or component failure.

The type of heating elements 18 preferably used generate very little radiated electromagnetic energy. In addition, the structure of the heating element or wire 18 is such that a major failure of the heating element or wire 18 will cause a change in resistance of the heating element 18. The controller 14 monitors the resistance and preferably shuts off the power to the heating elements 18 in the case of an abnormal situation.

The controller 14 includes a temperature boosting feature. This feature allows a user, in addition to setting a main setting for the electric blanket 10, to also set a higher heat setting for an initial period, for example the first hour of operation. Such an initial boosting setting can be any heat setting of the blanket 10, as long as it is higher than the main setting of the blanket 10.

In accordance with a preferred embodiment of the present invention, as will be described in detail below, the temperature setting circuitry of the present invention utilizes a single differential amplifier to sense the condition of both the PTC and NTC temperature sensing structures of the heating element, as discussed above.

In addition, a separate sensing circuit is preferably provided, which measures resistance of the heating element. This circuit cancels out line voltage changes that might give erroneous fault information.

According to another aspect of the present invention, the solid state device that controls power to the heating elements 18, i.e., a TRIAC, is backed by a mechanical relay. If the TRIAC becomes an electrical short circuit, such condition will be sensed and the relay will interrupt power to the electric blanket 10.

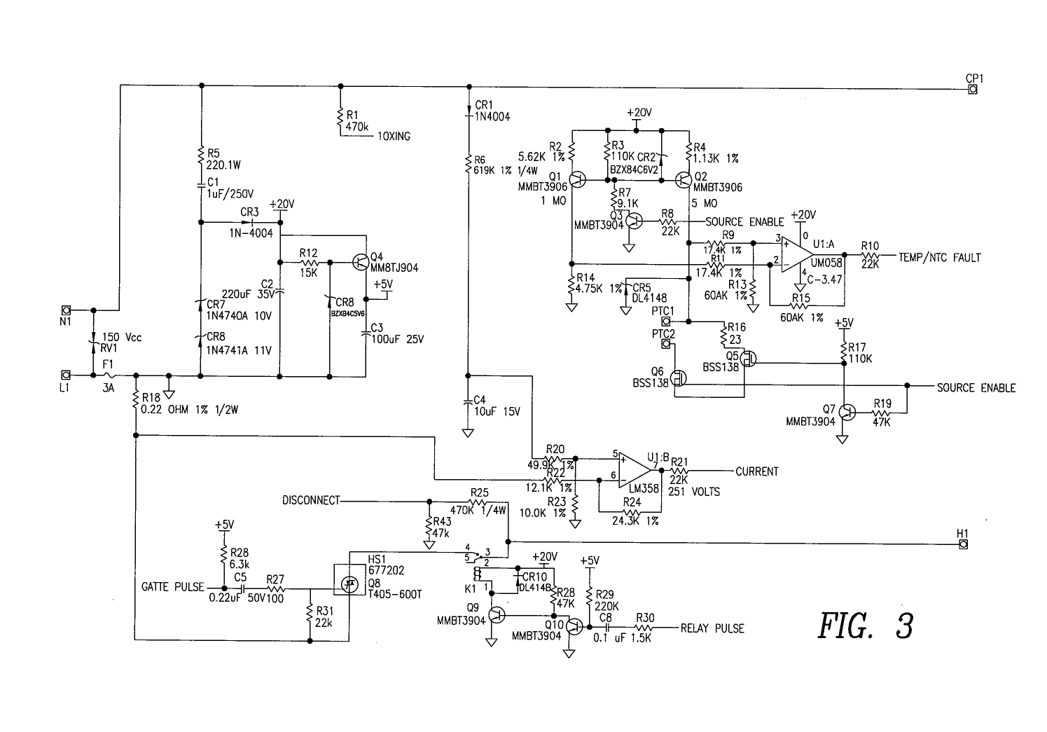

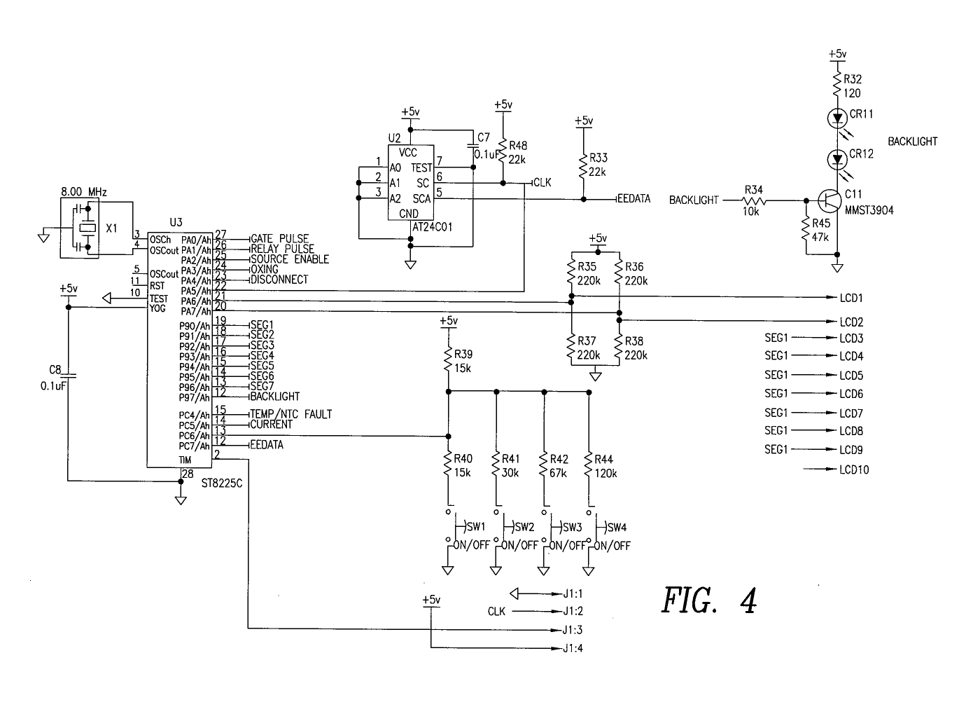

Exemplary circuitry for an exemplary embodiment of the controller 14 is shown in FIGS. 3 and 4. The circuit is controlled by a microcontroller. In an exemplary embodiment, as illustrated in FIGS. 3 and 4, the microcontroller is a ST Micro ST6225C. However, any equivalent controller may be used, as will be understood by those skilled in the art.

The description that follows will address each of the hardware subsystems as they relate to operation of the firmware. In the following description, certain assumptions will be followed in accordance with the illustrated embodiment. Of course, the invention is not limited to the exemplary embodiment. In particular, in the figures and the exemplary detailed description below:

The processor will be an ST Micro ST6225C.

Oscillator will be a ceramic resonator operating at 8.00±0.04 Mhz.

AC Line will be 108-132 Volt ac, 60 Hz.

A. Subsystems in a Exemplary Embodiment

Zero Crossing—The zero crossing signal (0XING) preferably goes positive during the half cycle of the ac line when Neutral is high with respect to Line. It will preferably switch to ground during the half cycle when Neutral is negative with respect to Line.

TRIAC Drive—The TRIAC gate drive preferably will consist of negative going, 200 usec long pulses that start at each edge of the zero crossing signal.

Relay Drive—The relay drive preferably will consist of positive going, 200 usec long pulses that start at each edge of the zero crossing signal.

LCD Drive—The LCD preferably will be ½ bias, ½ duty cycle with a total of 12 segments. It preferably requires 2 commons and 6 segment driver outputs from the processor. The LCD should preferably be operated at no less than 60 Hz frame rate.

Input Switches—To conserve I/O on the processor, the switches control binary weighted resistors that provide a ratio metric voltage to the A/D that is unique for any combination of switches that are closed.

Current Amplifier—This circuit is used to measure line voltage at zero current, and current through the heater wire. It is also used to detect faults of an open or shorted TRIAC, and a broken heater wire on both half cycles of the ac.

When the heater wire is being powered through the TRIAC, the line voltage preferably is measured by the A/D at the positive edge of zero crossing, and the current through the heater is measure at the peak of the negative half of the ac cycle. During calibration at 120 Vac line voltage, the A/D value for line voltage and current preferably are stored in non-volatile memory. During normal operation, the trip point for over current is adjusted by the firmware to compensate for the current flow variation due to the line voltage changing. This preferably is accomplished by the equation:
Itrip=Ical(Vline/Vcal)(1.25).

The 1.25 factor indicates that the trip current is 25% higher than the current that was measured at calibration after compensating for line voltage.

Temperature Amplifier—This circuit would typically include a differential amplifier that normally sets at approximately 0.8 volts when the PTC temperature sensing wire is 1K ohms. Temperature measurements is performed at the negative edge of zero crossing. As the temperature of the wire goes up, the resistance goes up and the voltage out of the amplifier goes up, in the exemplary embodiment at approximately 4 A/D steps per degree C. To measure the temperature, the current source preferably is enabled (Source_Enable=H) 2 msecs before the negative edge of the zero crossing. The PTC temperature reading is taken just prior to zero crossing and then the source is disabled at the zero crossing.

This circuit is also used to measure the resistance of the NTC insulation for a fault condition. This measurement is taken by the A/D at the peak of the positive half cycle when zero crossing is high, the TRIAC is off, and the current source is disabled. The circuit is preferably designed to detect NTC resistances in the range of 5Kohms or above.

EEPROM—Non-volatile memory preferably holds the calibration values of line voltage, heater current, last selected boost and heat level.

Disconnect—This signal indicates whether the blanket is plugged into the controller or the blanket has a broken wire. On power up of the processor, Disconnect is monitored for a logic high state at the positive peak of the ac, and for a logic low at the negative peak of the ac. If these states are found to be correct, the relay is turned on. Once the relay is on, this signal will be monitored each time the heater is to be powered on by the TRIAC to ensure the blanket is still connected and the wire is not broken. If a fault condition exists, the TRIAC will not be turned on, the safety relay turned off, and a fault condition will be declared. If a blanket disconnect occurs during normal TRIAC conduction, the disconnect will be sensed by the current amplifier.

Backlight—The Backlight LED's will preferably be driven at 50% duty cycle for full on and 12% for dim. The LED's preferably would be powered only during the positive half cycle of OXING.

Temperature Control Algorithm—The control algorithm will preferably be based on 19 ac cycles. Since there are, in this example, 15 different temperature settings from 1(L)-15(H), setting L will conduct 2 out of 19 cycles, and H will conduct 18 out of 19 cycles. The TRIAC will be turned off on the 19^{th} cycle and it will be used for testing for a shorted TRIAC and NTC fault. The above duty cycles are the nominal conditions for each setting. However, since this is a closed loop control system, the heater wire will preferably be turned on full power (18/19 cycles) until the desired set point temperature is obtained. At that point, the above duty cycle is followed until the temperature goes higher or lower than the set point by approximately 1.5 degrees F. or 3 A/D steps. Then the duty cycle is incremented or decremented by one step. Once a change in duty cycle is made, further changes to the duty cycle can only be made every 60 seconds due to the thermal lag of the system.

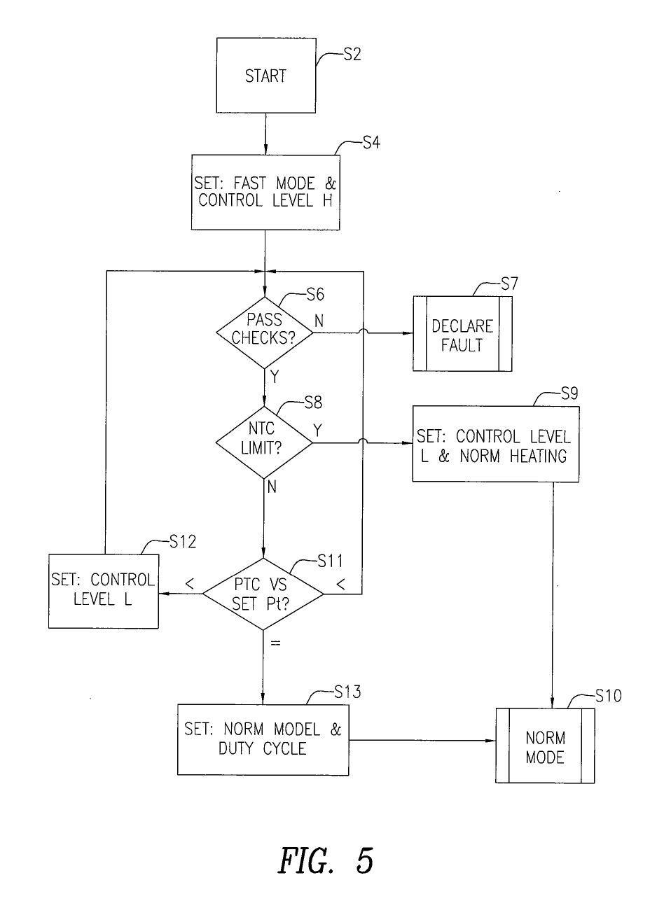

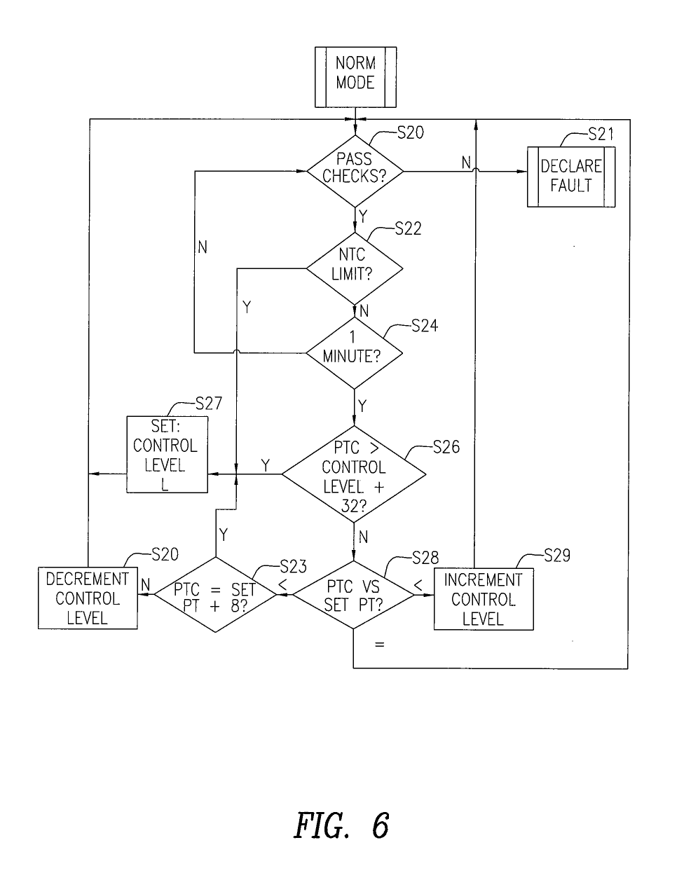

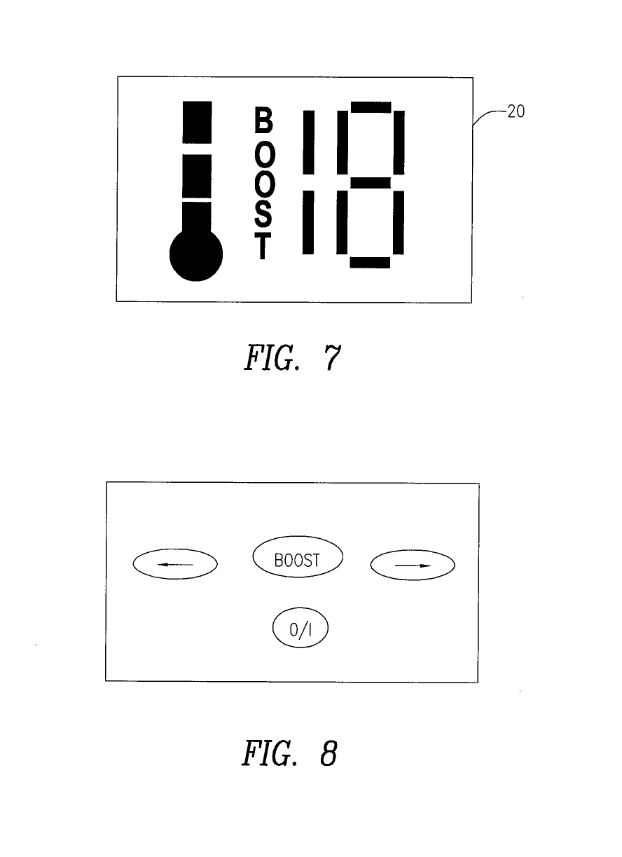

An exemplary overall operational flow for the power up and normal mode will next be described with reference to the flowcharts in FIGS. 5 and 6. Then, a more detailed example of a power-up mode, a calibration mode and a normal mode will be described with reference to the display and buttons shown in FIGS. 7 and 8. It should be noted that the present invention is not limited by the details given in the preceding or following examples.

B. Operational Description of an Exemplary Embodiment

In FIG. 5, after start step S2, the fast mode and control level H are set in step S4. At step S6, it is determined if the initial checks have been passed. If not, then the flow proceeds to step S7, where a fault is declared. If the checks are passed, then at step S8 it is determined if the negative temperature characteristic (NTC) limit has been reached. If so, then at step S9, the control level L and Normal heating is set and the flow proceeds to the normal mode at step S10. If the NTC limit has not been reached, then at step S11, the positive temperature coefficient (PTC) is compared with the set point. If there is not an equality, the flow either proceeds to step S12 to set control level to L, and then back to step S6, or the flow proceeds directly back to step S6. If the result is equality, the flow proceeds to S13 where the normal mode and duty cycle are set and flow then proceeds to step S10 to initiate the normal mode.

As shown in FIG. 6, in the normal mode it is determined in step S20 if the checks have been passed. If not, then at step S21 a fault is declared. If yes, the NTC limit is checked at step S22. If the NTC limit has been reached, then flow proceeds to steps S27 where the Control Level is set to L, and flow loops back to step S20.

If the NTC limit has not been reached, the flow proceeds to step S24 at which it is determined if a minute has passed. If not, the flow loops back to step S20. If a minute has passed, the flow proceeds to step S26 at which it is determined if the PTC is greater than the control level +32. If yes, then flow proceeds to step S27 at which the Control Level is set to L. If no, then the flow proceeds to step S28 to compare the PTC vs. the set point. Depending upon the results of step S28, if an inequality is determined, flow proceeds to either step S29, where the control level is incremented, or to step S23. At step S23, it is determined whether the PTC equals the set point +8. If yes, flow proceeds to step S27, discussed above. If no, flow proceeds to step S30, where the Control Level is decremented and the flow loops back to step S20. If an equality is determined at step S28, flow loops back to step S20.

A more detailed description of a preferred normal and fault mode operation of the electric blanket controller 14 will next be made in reference to FIGS. 7 and 8. The fault mode operation may change due to changes in operation initiated, for example, by UL.

The following display abbreviations will be used in the description below:
T1: Lower Thermometer Segment
T2: Middle Thermometer Segment
T3: Upper Thermometer Segment
BT: Boost Icon
HS: ½ Digit Heat Setting Numerical Value
BL: Backlight Status (OFF/LOW/HIGH)

The control buttons, as shown in FIG. 8, are abbreviated as follows:
0/1 On/Off
> Temperature Increment
< Temperature Decrement
TB Temp Boost Button

Power-up Mode:

In an exemplary embodiment, upon plugging unit into AC power source, the unit will undergo a built in self-test to determine proper operation of the LCD 20, the controller 14 and the blanket body 12. The LCD 20 will display all segments and any anomalies will be reported with, for example, the following error codes:

| Fault | Error Code |
|---|---|
| Microcontroller problem | E0 |
| Non-connected load/broken wire | E1 |
| Shorted TRIAC | E2 |
| Open TRIAC (apply power briefly) | E3 |
| Current out of range (apply power briefly) | E4 |
| NTC layer resistance too low | E5 |
| PTC resistance out of range | E6 |

Throughout these tests, in the illustrated example, the backlight will be on HIGH. If tests are passed, the safety relay will be turned off, the LCD 20 will go blank indicting OFF mode and the backlight will be shut off. Unit will continue to monitor for disconnected load in the OFF mode.

If any tests fail, that condition would, for example, be indicated with the appropriate error code by alternating “E” and the error code number on the numerical display. The safety relay would be immediately turned off also. If any error is detected at this time, in the example, the I/O button would have to be toggled to attempt a restart of the controller.

Calibration Mode:

Calibration mode is, in the example, entered by powering up the controller while simultaneously holding down the 0/1, <, and > buttons. The LCD 20 displays a C for calibration to indicate this mode. During calibration, the line voltage value and current level is stored in EEPROM. The line voltage must be maintained at 120±0.5 Vac during the calibration tests. Any problems are reported with the following error codes:

| Fault | Error Code |
|---|---|
| Calibration line voltage <98%, >102% of the default (129) | E7 |
| Calibration current <95%, >105% of the default (169) | E8 |
| EEPROM write/read back problem | E9 |

Normal Mode:

In the example, when the 1/0 button is pressed, the unit will turn on, and continuously perform the tests as in the OFF mode. The numerical display will show the last heat setting selected. Note: The last heat setting is stored in non-volatile EEPROM memory when the backlight changes to dim after a heat setting has been selected. Default for initial power up will be heat setting 5. If the <or > button is pressed, the heating setting will decrement or increment accordingly. The unit will begin applying power to the heating element to drive the PTC resistance to give the appropriate ADC Counts.

| Setting | ADC Counts | Element Temp (Approx. ° C.) |
|---|---|---|
| L (1) | 03CH | 25 |
| 5 | 06AH | 35 |
| 10 | 093H | 45 |
| H (15) | 0B4H | 55 |

In the exemplary embodiment, the thermometer icon slowly scrolls from bottom to top to indicate unit is warming up, and stops scrolling and remain on once temperature is reached. If the heat setting is changed after reaching the initial setting, the thermometer again slowly scrolls from bottom to top until the new heat setting is achieved. During this mode, the unit checks for all error conditions. If an error is detected, the unit shuts down and turns off the safety relay. The unit can be rest by toggling the 1/0 switch.

Temperature is preferably controlled by changing the on/off duty cycle over a 19 cycle period as follows:

| Setting | On/Off AC Cycles |
|---|---|
| L | 2/17 |
| 2 | 4/15 |
| 3 | 6/13 |
| 4 | 7/12 |
| 5 | 8/11 |
| . | . |
| . | . |
| . | . |
| . | . |
| . | . |
| . | . |
| H | 18/19 |

The unit preferably turns off the TRIAC on the 19^{th} cycle for fault checks.

The unit preferably uses the H duty cycle to reach the desired heat setting as quickly as possible if the desired setting is higher than the current positive temperature coefficient (PTC) resistance value. If the desired setting is lower than the current PTC resistance value, the L duty cycle is selected. Once the desired setting is reached, the duty cycle is continuously adjusted, if necessary, up or down by one level setting every minute to maintain the desired temperature. If, while reducing the duty cycle, the temperature of the blanket continues to rise by more than 8 A/D values above the desired setting, the controller turns off the TRIAC until the temperature is reduced to the desired level, at which point it will start normal control again.

The unit preferably has an auto off capability that will automatically shut off the blanket heater after ten hours. This time out can be reset by toggling the I/O switch.

The LCD backlight will normally be on LOW brightness setting unless a switch is pressed, at which time it will illuminate at the HIGH setting. It reverts back to the LOW setting five seconds after the last switch press.

Boost Mode:

If button TB is pressed, the unit defaults to the High setting (“H” on the numerical display) then reverts back to the normal setting after one hour. The BT icon preferably will be displayed in this mode. While the BT icon is displayed, the user can change the boost mode setting by pressing the <or > button. This setting is stored in non-volatile EEPROM memory. The boost mode may be cancelled by pressing TB button a second time. The boost mode setting must be higher than the normal setting unless the normal setting is H, in which case the boost is also H. As discussed above, the boost mode allows the user to adjust the level of the boost, in addition to adjusting the overall temperature setting.

The above descriptions are merely exemplary in nature. Various ways of implementing the present invention would be understood based upon the above description, which is not limiting.

What is claimed is:

1. An electric blanket comprising:
a blanket body comprising a heating element embedded in the blanket body; and
a controller electrically coupled to the heating element for controlling temperature sensed in the heating element, the controller comprising:
a temperature control circuit for independently setting and adjusting first and second temperatures; and
a power control circuit for adjusting power supply to the heating element based on a detected temperature of the heating element and one of the first and second temperatures.

2. The electric blanket of claim 1 further comprising a timing circuit for determining a predetermined period of time during which the temperature of the heating element is maintained at the first temperature.

3. The electric blanket of claim 2, wherein the controller maintains the temperature of the heating element at the second temperature after the predetermined period of time expires.

4. The electric blanket of claim 1 further comprising one or more control buttons for a user to adjust the first temperature and the second temperature.

5. The electric blanket of claim 1 further comprising a display for displaying an indicator when the first temperature is being adjusted.

6. The electric blanket of claim 1, wherein the first temperature is adjustable after the controller is powered up.

7. The electric blanket of claim 1, wherein the first temperature differs from the second temperature.

8. The electric blanket of claim 1 further comprising a mechanical relay for backing the power control circuit, the mechanical relay interrupting power supply to the heating element if an electrical short circuit occurs.

9. The electric blanket of claim 1, wherein the heating element has a positive temperature coefficient or negative temperature coefficient structure.

10. The electric blanket of claim 9 further comprising a single differential amplifier for sensing a condition of the heating element.

11. A controller circuitry for controlling temperature sensed in a heating element, comprising:
a temperature control circuit for setting and adjusting first and second temperatures after the controller circuitry is powered up;
a temperature detecting circuit for receiving a temperature signal detected from the heating element;
a power control circuit for adjusting power supply to the heating element based on the detected temperature signal and one of the first and second temperatures.

12. The controller circuitry of claim 11 further comprising a non-volatile memory device for storing the first temperature.

13. The controller circuitry of claim 11, wherein the temperature control circuit comprises a default value of the first temperature and the default value is the maximum value among all adjustable values of the first temperature.

14. The controller circuitry of claim 11, wherein the first temperature differs from the second temperature.

15. The controller circuitry of claim 11, wherein the first temperature is higher than the second temperature.

16. A method of operating an electric blanket, the method comprising:
setting up a first temperature to which the electric blanket is heated when the electric blanket is powered up;
setting up a second temperature to which the electric blanket is heated after it is powered up;
wherein the first temperature is adjustable after the electric blanket is powered up.

17. The method of claim 16 comprising adjusting the first temperature after the electric blanket is powered up.

18. The method of claim 17, wherein the first temperature differs from the second temperature.

19. The method of claim 16, further comprising setting the first temperature to be higher than the second temperature.

20. The method of claim 16 comprising operating the electric blanket under the first temperature for up to one hour, after which the electric blanket is controlled to operate at the second temperature.
